(19) United States
(12) Patent Application Publication
(10) Pub. No.: US 2006/0140168 A1
(43) Pub. Date: Jun. 29, 2006

(54) Electric power-generating apparatus and method

(75) Inventor: Jae-kwan Ryoo, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/315,006

(22) Filed: Dec. 23, 2005

(30) Foreign Application Priority Data
Dec. 23, 2004 (KR) 10-2004-0111340

(51) Int. Cl. H04L 12/28

(52) U.S. Cl. 370/351

(57) ABSTRACT

An apparatus and method for generating electric power by using magnetic fields are provided. A sensor node has a coil unit having a spiral structure in a plane that generates an induced electromotive force by using magnetic fields; a conversion unit configured to convert the induced electromotive force into DC power; and an integrated circuit for performing operations using the converted DC power. The sensor node may be disposed on a flexible plate substrate or film, and is attached to or placed on readily available electronic appliance cases which serve as magnetic field sources. The plate substrate or film can be provided with a metal shielding film. The metal shielding film may also be grounded, or the plate substrate or film may be provided with a metal shielding film accompanying an impedance-matching RF circuit for preventing reflection of magnetic fields passing through the coil unit.

### CROSS-REFERENCE TO RELATED APPLICATIONS

This application claims benefit under 35 U.S.C. § 119 from Korean Patent Application No. 2004-111340, filed on Dec. 23, 2004 in the Korean Intellectual Property Office, the entire contents of which are incorporated herein by reference.

### BACKGROUND OF THE INVENTION

1. Field of the Invention

Apparatuses and methods consistent with the present invention relate to sensor nodes for generating electric power, and more particularly to sensor nodes for generating electric power by using magnetic fields.

2. Description of the Related Art

FIG. 1 is a view showing a home server 110 and plural sensor nodes 120 to 136 that constructs a home network 100. The home network 100 can include electronic devices such as home appliances in addition to the home server 110 and the sensor nodes 120 to 136. The kinds of electronic devices will be described later. Further, FIG. 1 shows only one home server, but a home network can contain two or more home servers depending on the requirements of users. The sensor nodes 120 to 136 collect information on target regions established by a user. The information can be ambient temperatures, object movements, or other information collected by sensors in the art. The sensor nodes 120 to 136 send the collected information to the home server 110. The home server 110 receives the information sent from the sensor nodes 120 to 136 that constitute the home network 100. Sensor nodes located within a certain distance from the home server 110 send information directly to the home server 110. However, sensor nodes located beyond the certain distance send the collected information to the other sensor nodes adjacent to the home server 110 rather than directly to the home server 110. As stated above, because the sensor nodes located beyond the certain distance send information by using neighboring nodes, power consumption caused by information transmissions can be minimized. That is, the distance between the home server 110 and the sensor nodes is, in general, proportional to the power consumed when the sensor nodes send the information to the server. Thus, the sensor nodes located beyond the certain distance from the home server 110 use the other sensor nodes to send the collected information, so that the power consumption caused by data transmissions can be minimized.

The sensor nodes are supplied from batteries mounted therein with electric power necessary to send the collected information to the home server or to send the information received from the other sensor nodes to the home server. Thus, if the batteries have run out, the sensor nodes can not collect information, nor send the collected information. Users have to replace the batteries at certain time intervals to drive the sensor nodes again, and such battery replacement causes an extra cost.

### SUMMARY OF THE INVENTION

An aspect of the present invention is to provide a method for the sensor nodes to generate electric power to drive themselves.

Another aspect of the present invention is to provide a solution to the cost problem caused by battery replacement because the sensor nodes directly generate electric power to drive themselves.

Yet another aspect of the present invention is to provide a method for preventing the sensor nodes from stopping driving thereof even when the batteries have run out.

According to an aspect of the present invention, there is provided an electric power-generating apparatus, comprising a coil unit having a spiral structure in a plane for generating an induced electromotive force by using magnetic fields; a conversion unit for converting the induced electromotive force into DC power; and an integrated circuit (IC) chip for performing operations by using the converted DC power.

The electric power-generating apparatus may be attached to a flexible plate substrate or film, and the plate substrate or film can have a metal shielding film as a magnetic flux offset prevention unit integrating the magnetic fields into one direction depending on the circumstances of magnetic field sources.

The metal shielding film may be grounded, or the flexible plate substrate or film can be provided with the metal shielding film accompanying an impedance-matching RF circuit for preventing the magnetic fields that pass through the coil unit from being reflected by the metal shielding film.

According to another aspect of the present invention, there is provided an electric power-generating method comprising generating an induced electromotive force from magnetic fields in the air by using a coil unit having a spiral structure in a plane; converting the induced electromotive force into DC power; and performing operations by using the converted DC power.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a view for showing a home server and sensor nodes that constitute a home network;

FIG. 2 is a view for showing a structure of a sensor node according to an exemplary embodiment of the present invention;

FIG. 3 is a view for showing a coil unit of a sensor node according to an exemplary embodiment of the present invention; and

FIG. 4 is a view showing another coil unit of a sensor node according to another exemplary embodiment of the present invention.

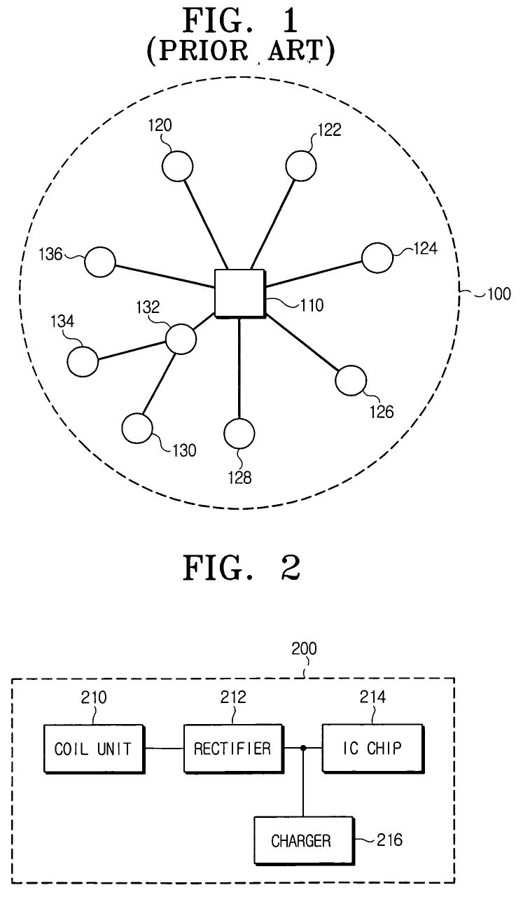

### DETAILED DESCRIPTION OF EXEMPLARY EMBODIMENTS

An exemplary embodiment of the present invention provides a method for sensor nodes to generate electric power by using magnetic fields existing in the air and to drive themselves by using the generated power.

Table 1 as below shows the electric field strength or magnetic field strength measured 30 cm away from various exemplary electronic devices.

TABLE 1

| Electronic | Electric field | Electronic | Magnetic field |
|---|---|---|---|
| appliances | strength | Appliances | Strength |
| Electric cooker | 4 | Microwave oven | 3-30 |
| Toaster | 40 | Dish washer | 7-14 |
| Electric blanket | 250 | Refrigerator | 0.1-3 |
| Electric iron | 60 | Laundry washer | 2-20 |
| Hair dryer | 40 | Hair dryer | 0.7-3 |
| evaporator | 40 | Toaster | 0.6-8 |
| refrigerator | 60 | Electric iron | 1-4 |
| television | 30 | Mixer | 6-150 |
| Electric | 90 | Vacuum cleaner | 20-200 |
| gramophone | | | |
| Coffee pot | 30 | Dryer | 1-100 |
| Vacuum cleaner | 16 | Television | 0.3-20 |
| Mixer | 50 | Fluorescent lamp | 20-40 |
| Glow lamp | 2 | Desk lamp | 2-20 |

In general, the strengths of electric fields and magnetic fields are inversely proportional to the square of distance. Thus, the measured strengths of electric fields and magnetic fields rapidly decrease as the distance from electronic devices increases. In case of an electric razor, for example, if the strength of a magnetic field measured at a point 15 cm away from the electric razor is 150 mG, the strength of the magnetic field measured at a point 30 cm away from the razor is 22 mG. Further, the strength of a magnetic field measured at a point 45 cm away from the electric razor is 6.7 mG, the strength of the magnetic field measured at a point 60 cm away from the razor is 2.6 mG, and the strength measured at a point 90 cm away from the razor is 1.5 mG. However, a very strong magnetic field exists on the surface of electronic devices with little magnetic field attenuation. The present invention can be mounted on the surface of electronic devices, so the strength of a magnetic field can be used as it is, without little attenuation thereof. Since magnetic and electric fields are interchangeable, electric power can be generated by electric fields existing in the air as well as by magnetic fields existing in the air.

As stated above, the home network has mixed electric and magnetic fields caused by electromagnetic waves generated from home appliances. Thus, an exemplary embodiment of the present invention uses the mixed electric and magnetic fields on the home network to generate power to be used in the sensor nodes.

FIG. 2 is a view for showing a structure of a sensor node 200 according to an exemplary embodiment of the present invention. The sensor node 200 has a coil unit 210, a rectifier (or conversion unit) 212, a charger 216, an integrated circuit (IC) chip 214. The coil unit 210 generates electric power by using magnetic fields existing in the air. The induced electromotive force of the coil unit 210 is calculated in Equation 1.
induced electromotive force (V)=−(N·d)/dt, [Equation 1]
wherein N denotes the number of coil turns, d a rate of magnetic flux changes, and dt a rate of time change. As can be appreciated from [Equation 1], the induced electromotive force is proportional to the number of coil turns and the rate of magnetic flux changes per unit time.

The rectifier 212 converts AC power induced by the coil unit 210 into DC power. The charger 216 sends to the IC chip 214 part of the DC power received from the rectifier 212, and charges itself with the remaining DC power. The IC chip 214 operates by using the power charged in the charger 216 if any power is not supplied from the rectifier 212. The charger 216 can be built separately or included in the IC chip 214 or in the rectifier 212.

The IC chip 214 carries out functions established in the sensor node 200. That is, the IC chip 214 carries out functions of sensing ambient temperatures, detecting intruders, or other sensing functions known in the art. The detailed functions of the IC chip 214 are omitted since the functions are not related to the present invention.

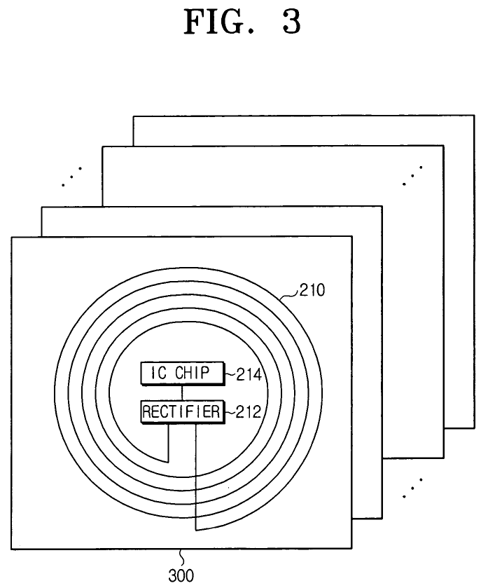

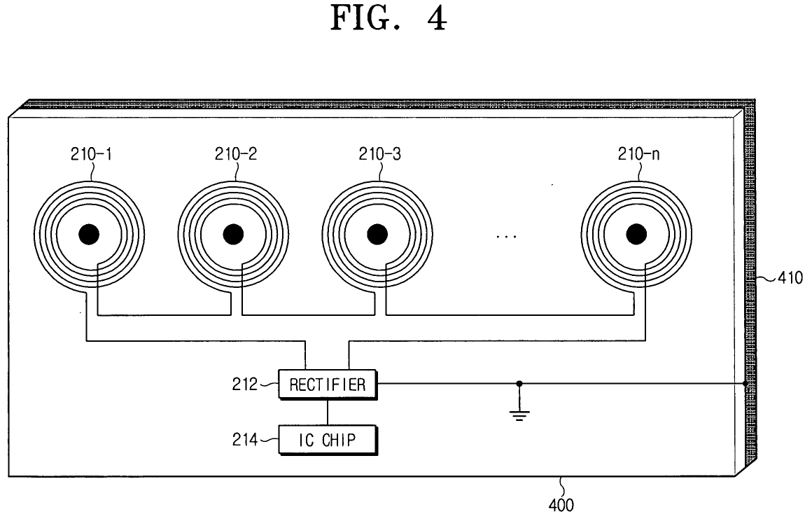

FIG. 3 is a view for showing another sensor node according to an exemplary embodiment of the present invention. As shown in FIG. 2, the sensor node of FIG. 3 has a coil unit 210, a rectifier 212, a charger (not shown), and IC chip 214. FIG. 3 shows in detail how the coil unit 210 is formed, for example.

As shown in FIG. 3, the coil unit 210 is formed with coils wound in spirals about the rectifier 212 and the IC chip 214. The coil unit 210 has coils wound in the two-dimensional plane rather than in the three-dimensional plane for the purposes of downsizing.

As stated above, the induced electromotive force caused by the coil unit 210 is sent to the rectifier 212, and the induced electromotive force is rectified in the rectifier 212, and sent to the IC chip 214 or the charger 216. The sensor node is attached to a flexible plate substrate[[,]] or a film 300, or similar substrate or film known in the art, and the plate substrate or the film 300 is attached to home appliances that generate electromagnetic waves, so that the electric power-generating efficiency can be improved. Table 1 shows such efficiencies of home appliances.

Further, as shown in FIG. 3, the sensor node has not only one coil unit 210, but also can have two or more coil units. The plate substrates or films are stacked one on another so a coil unit of at least two substrates or films is formed. By doing so, the coil unit can generate more electric power. If at least two coil units are built together, the individual coil units are interconnected or directly connected to the rectifier. In addition, the sensor node can have a ferrite-coated magnetic substance such as iron core at the center of the plate or the film of the coil unit 210 in order to maximize the induced electromotive force. That is, the ferrite-including magnetic substance increases the induced electromotive force of the coil unit.

FIG. 4 shows another coil unit of a sensor node according to an exemplary embodiment of the present invention.

In FIG. 4, one plate substrate or film 400 has plural coil units 210-1 to 210-n formed thereon. For example, FIG. 4 shows that one plate substrate or film 400 has n coil units 210-1 to 210-n formed thereon.

The individual coil units 210-1 to 210-n can be built to be interconnected as shown in FIG. 4, or the individual coil units 210-1 to 210-n each can induce and send an electromotive force to the rectifier 212. Further, at least two plate substrates or films 400 can be stacked together in order that the efficiency of electromotive force generation is improved. The coil units 210-1 to 210-n forming each plate substrate or film 400 can be interconnected or independent, and send an electromotive force to the rectifier 212, respectively. As stated above, the ferrite-including iron core may be selectively located at the centers of the coil units 210-1 to 210-n in order to increase the induced electromotive force.

Further, as shown in FIG. 4, a shielding screen 410 can be formed on the rear side of the plate substrate or film 400 to prevent the offset of electromagnetic waves, thereby increasing the induced electromotive force. That is, if the shielding screen 410 is not formed, there exist, together, electromagnetic waves traveling from the front to the back of the coil units 210-1 to 210-n and electromagnetic waves traveling from the back to the front of the coil units 210-1 to 210-n. Thus, the electromagnetic waves traveling from the front to the back of the coil units 210-1 to 210-n collide with the electromagnetic waves traveling from the back to the front of the coil units 210-1 to 210-n. Such collision reduces an amount of flux changing per unit time, causing a decrease in the induced electromotive force.

Therefore, the shielding screen 410 may be formed on the back of the plate substrate or film 400, so as to cut off the electromagnetic waves traveling from the back to the front of the coil units 210-1 to 210-n. Moreover the same effect can be obtained if the shielding screen 410 is formed on the front of the plate substrate or film 400. The shielding screen 410 can be formed of a metal film known in the art.

Further, according to another exemplary embodiment of the present invention a method is provided that is capable of preventing the electromagnetic waves traveling from the front to the back of the coil units 210-1 to 210-n from being reflected by the shielding screen 410. The electromagnetic waves reflected by the shielding screen 410 have the same influence on the electromagnetic waves traveling from the front to the back of the coil units 210-1 to 210-n as the electromagnetic waves traveling from the back to the front of the coil units 210-1 to 210-n have.

Therefore, the shielding screen 410 has to absorb the electromagnetic waves in order to eliminate the electromagnetic waves reflected by the shielding screen 410. Two methods may be used to absorb the electromagnetic wave: a method of grounding the shielding screen 410 and a method of using impedance matching.

The method of grounding the shielding screen 410 is mainly used for low frequencies, and the method of using the impedance matching is mainly used for high frequencies. There is a method of inserting intermediate impedance of ¼-wavelength between two impedance terminals, that is, the shielding screen and the plate substrate, for the impedance-matching method, but the impedance-matching method has a drawback of taking much space. Another impedance-matching method is to build an RF circuit using the Smith chart and LC devices on top of the shielding screen or between the shielding screen 410 and the plate substrate or the film 400. The method of absorbing the electromagnetic waves by using the impedance matching will not be described in detail. However, an impedance-matching RF chip can be inserted on top of the shielding screen 410 or between the shielding screen and the plate substrate or the film 400.

The present invention describes the sensor nodes constituting a home network, but is not limited thereto. That is, the present invention can be applied to any devices performing operations by using electric power.

As aforementioned, the present invention generates electric power by using magnetic fields, and uses the generated electric power as a driving source of the sensor nodes. The present invention also generates electric power by using the magnetic fields, so the present invention does not need batteries to be replaced at certain time intervals to drive the sensor nodes, thereby solving the extra cost problem. Further, the present invention prevents the failure of the sensor nodes in advance that is caused when users inadvertently fail to replace batteries.

The foregoing embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An electric power-generating apparatus, comprising:
a coil unit having a spiral structure in a plane that generates an induced electromotive force by using magnetic fields;
a conversion unit configured to convert the induced electromotive force into DC power; and
an integrated circuit for performing operations by using the converted DC power.

2. The apparatus as claimed in claim 1, wherein the apparatus is attached to a plate substrate or film.

3. The apparatus as claimed in claim 2, wherein a metal shielding film is disposed on the plate substrate or film to prevent magnetic fields from offseting.

4. The apparatus as claimed in claim 3, wherein the metal shielding film is grounded.

5. The apparatus as claimed in claim 3, wherein an impedance-matching RF circuit is arranged over the metal shielding film or between the metal shielding film and the plate substrate or film in order to prevent magnetic fields passing through the coil unit from being reflected by the metal shielding film.

6. The apparatus as claimed in claim 2, wherein the plate substrate or film has at least two coil units disposed thereon.

7. The apparatus as claimed in claim 1, wherein the apparatus is attached to at least two stacked plate substrates or films.

8. The apparatus as claimed in claim 7, wherein the at least two stacked plate substrates or films have at least two coil units disposed thereon.

9. The apparatus as claimed in claim 1, further comprising an electric charger which charges with the DC power converted by the conversion unit.

10. The apparatus as claimed in claim 1, wherein a ferrite-including iron core is inserted at a center of the coil unit in order to maximize the induced electromotive force.

11. An electric power-generating method, comprising:
generating an induced electromotive force from magnetic fields by using a coil unit having a spiral structure in a plane;
converting the induced electromotive force into DC power; and
performing operations by using the converted DC power.

12. The method as claimed in claim 11, further comprising charging using the DC power.
